(19) United States
(12) Patent Application Publication
(10) Pub. No.: US 2024/0422712 A1
(43) Pub. Date: Dec. 19, 2024

(54) METHODS TO CONTROL NON-ACCESS STRATUM (NAS) TIMERS AT OR AFTER DISCONTINUOUS COVERAGE AND DECLARE STATE OF USER EQUIPMENT AT AND AFTER END OF DISCONTINUOUS COVERAGE

(71) Applicant: Media Tek Singapore Pte. Ltd., Singapore (SG)

(72) Inventors: Puneet (last name not provided), Bengaluru KA (IN); Marko NIEMI, Oulu (FI)

(21) Appl. No.: 18/741,106

(22) Filed: Jun. 12, 2024

(30) Foreign Application Priority Data
Jun. 15, 2023 (IN) 202321040859
Jul. 10, 2023 (IN) 202321046284

(51) Int. Cl. H04W 60/04; H04W 8/08; H04W 84/04

(52) U.S. Cl. CPC H04W 60/04; H04W 8/08; H04W 84/042

(57) ABSTRACT

A method to control non-access stratum (NAS) timers at or after discontinuous coverage includes the following steps. An unavailability period is activated due to discontinuous coverage. All the NAS timers are stopped except for exceptional timers. Associated procedures are aborted. A method to declare the state of user equipment (UE) at and after the end of discontinuous coverage includes the following steps. The UE returns in coverage of a tracking area (TA) in a current registration after being out of coverage due to the discontinuous coverage. The UE runs or starts a discontinuous coverage maximum time offset timer. The UE enters a specific xMM state. The UE performs an xMM procedure upon expiry of the discontinuous coverage maximum time offset timer. The specific xMM state includes an xMM-REGISTERED.ATTEMPTING-REGISTRATION-UPDATE state.

### CROSS REFERENCE TO RELATED APPLICATIONS

This application claims priority of India patent application No. 202321040859, filed on Jun. 15, 2023, and India patent application No. 202321046284, filed on Jul. 10, 2023, the entirety of which are incorporated by reference herein.

### BACKGROUND OF THE INVENTION

### Field of the Invention

The present invention relates to a method for 5G NR operation in discontinuous coverage, and, in particular, to methods to control non-access stratum (NAS) timers at or after discontinuous coverage and declare the state of the user equipment at and after the end of discontinuous coverage.

### Description of the Related Art

Deployment option for satellite E-UTRAN or NG-RAN access is provided in current technology, in which shorter periods of satellite E-UTRAN or NG-RAN access radio coverage are followed by longer periods of satellite E-UTRAN or NG-RAN access coverage gaps. During coverage gaps, the access stratum may be deactivated. These coverage gaps are called discontinuous coverage.

When user equipment (UE) enters satellite discontinuous coverage, it is not clear what will happen to NAS ongoing timers like T3412, T3410, T3346, etc.

When UE comes out of a discontinuous coverage situation or access-stratum is activated after discontinuous coverage, then the UE shall start a random timer running (within range of the stored discontinuous coverage maximum NAS signaling wait time value). During the timer's running window, the UE EMM/5GMM state is not defined, i.e., the UE should move to an EMM/5GMM state after leaving discontinuous coverage.

### BRIEF SUMMARY OF THE INVENTION

An embodiment of the present invention provides a method to control non-access stratum (NAS) timers at or after discontinuous coverage. The method is applied to user equipment (UE). The method includes the following steps. An unavailability period is activated due to discontinuous coverage. All the NAS timers except for exceptional timers are stopped. Associated procedures are aborted. The exceptional timers include T3412, T3346, T3396, T3447, any backoff timers, T3247, and a timer controlling a periodic search for a home public land mobile network (HPLMN) or an equivalent HPLMN (EPLMN), or higher prioritized PLMNs.

The method further includes deactivating an access stratum.

According to the method described above, the unavailability period includes a period during the discontinuous coverage and/or a period when an access stratum of the UE is deactivated.

An embodiment of the present invention also provides a method to declare the state of user equipment (UE) at and after the end of discontinuous coverage. The method is applied to user equipment (UE). The method includes the following steps. The UE returns in coverage of a tracking area (TA) in a current registration after being out of coverage due to the discontinuous coverage. The UE runs or starts a discontinuous coverage maximum time offset timer. The UE enters a specific xMM state. The UE performs an xMM procedure upon expiry of the discontinuous coverage maximum time offset timer. The specific xMM state includes an xMM-REGISTERED.ATTEMPTING-REGISTRATION-UPDATE state.

According to the method described above, the xMM-REGISTERED.ATTEMPTING-REGISTRATION-UPDATE state is a 5GMM-REGISTERED.ATTEMPTING-REGISTRATION-UPDATE state or an EMM-REGISTERED.ATTEMPTING-TO-UPDATE.

According to the method described above, the xMM procedure is a registration procedure for mobility registration update or a tracking area updating procedure.

The method further includes the following steps. The specific xMM state is stored before entering a discontinuous coverage situation or before an access stratum is deactivated due to the discontinuous coverage. The specific xMM state is chosen once the UE comes out of the discontinuous coverage and the discontinuous coverage maximum time offset timer is started or running.

The method further includes not initializing any xMM procedures in a state entered at, during, or after the discontinuous coverage maximum time offset timer is running, except for emergency services.

The method further includes staying in the same xMM state until the discontinuous coverage maximum time offset timer has expired. The same xMM state includes an NO-Cell state.

An embodiment of the present invention also provides user equipment (UE). The UE includes a processor. The processor activates an unavailability period due to discontinuous coverage, stops all non-access stratum (NAS) timers, and aborts associated procedures except for exceptional timers, and aborts associated procedures. The processor returns in coverage of a tracking area (TA) in a current registration after being out of coverage due to the discontinuous coverage, runs or starts a discontinuous coverage maximum time offset timer, enters a specific xMM state, and performs an xMM procedure upon expiry of the discontinuous coverage maximum time offset timer. The specific xMM state includes an xMM-REGISTERED.ATTEMPTING-REGISTRATION-UPDATE state.

According to the UE described above, the exceptional timers include T3412, T3346, T3396, T3447, any backoff timers, T3247, and a timer controlling a periodic search for an HPLMN or an EPLMN, or higher prioritized PLMNs.

According to the UE described above, the xMM-REGISTERED.ATTEMPTING-REGISTRATION-UPDATE state is a 5GMM-REGISTERED.ATTEMPTING-REGISTRATION-UPDATE state or an EMM-REGISTERED.ATTEMPTING-TO-UPDATE.

According to the UE described above, the unavailability period includes a period during the discontinuous coverage and/or a period when an access stratum of the UE is deactivated.

According to the UE described above, the xMM procedure is a registration procedure for mobility registration update or a tracking area updating procedure.

According to the UE described above, the processor stores the specific xMM state before entering a discontinuous coverage situation or before an access stratum is deactivated due to the discontinuous coverage, and chooses the specific xMM state once the UE comes out of the discontinuous coverage and the discontinuous coverage maximum time offset timer is started or running.

According to the UE described above, the processor does not initialize any xMM procedures in a state entered at, during, or after the discontinuous coverage maximum time offset timer is running, except for emergency services.

According to the UE described above, the processor stays in the same xMM state until the discontinuous coverage maximum time offset timer has expired.

According to the UE described above, the same xMM state includes an NO-Cell state.

According to the UE described above, the UE deactivates an access stratum.

### BRIEF DESCRIPTION OF THE DRAWINGS

The present invention can be more fully understood by reading the subsequent detailed description and examples with references made to the accompanying drawings, wherein:

FIG. 1 shows a flow chart of a method to control non-access stratum (NAS) timers at or after discontinuous coverage in accordance with some embodiments of the present invention;

FIG. 2 shows a flow chart of a method to declare the state of user equipment (UE) at the end, and after the end, of discontinuous coverage in accordance with some embodiments of the present invention;

FIG. 3 shows a flow chart of the method to declare the state of the UE at and after the end of discontinuous coverage in FIG. 2 in accordance with some embodiments of the present invention; and

FIG. 4 shows a schematic diagram of a communication system 400 in accordance with some embodiments of the present invention.

### DETAILED DESCRIPTION OF THE INVENTION

In order to make the above purposes, features, and advantages of some embodiments of the present invention more comprehensible, the following is a detailed description in conjunction with the accompanying drawing.

Certain terms are used throughout the description and following claims to refer to particular components. As one skilled in the art will understand, electronic equipment manufacturers may refer to a component by different names. This document does not intend to distinguish between components that differ in name but not function. It is understood that the words “comprise”, “have” and “include” are used in an open-ended fashion, and thus should be interpreted to mean “include, but not limited to . . . ”. Thus, when the terms “comprise”, “have” or “include” used in the present invention are used to indicate the existence of specific technical features, values, method steps, operations, units or components. However, it does not exclude the possibility that more technical features, numerical values, method steps, work processes, units, components, or any combination of the above can be added.

The directional terms used throughout the description and following claims, such as: “on”, “up”, “above”, “down”, “below”, “front”, “rear”, “back”, “left”, “right”, etc., are only directions referring to the drawings. Therefore, the directional terms are used for explaining and not used for limiting the present invention. Regarding the drawings, the drawings show the general characteristics of methods, structures, or materials used in specific embodiments. However, the drawings should not be construed as defining or limiting the scope or properties encompassed by these embodiments. For example, for clarity, the relative size, thickness, and position of each layer, each area, or each structure may be reduced or enlarged.

When the corresponding component such as layer or area is referred to as being “on another component”, it may be directly on this other component, or other components may exist between them. On the other hand, when the component is referred to as being “directly on another component (or the variant thereof)”, there is no component between them. Furthermore, when the corresponding component is referred to as being “on another component”, the corresponding component and the other component have a disposition relationship along a top-view/vertical direction, the corresponding component may be below or above the other component, and the disposition relationship along the top-view/vertical direction is determined by the orientation of the device.

It should be understood that when a component or layer is referred to as being “connected to” another component or layer, it can be directly connected to this other component or layer, or intervening components or layers may be present. In contrast, when a component is referred to as being “directly connected to” another component or layer, there are no intervening components or layers present.

The electrical connection or coupling described in this disclosure may refer to direct connection or indirect connection. In the case of direct connection, the endpoints of the components on the two circuits are directly connected or connected to each other by a conductor line segment, while in the case of indirect connection, there are switches, diodes, capacitors, inductors, resistors, other suitable components, or a combination of the above components between the endpoints of the components on the two circuits, but the intermediate component is not limited thereto.

The words “first”, “second”, “third”, “fourth”, “fifth”, and “sixth” are used to describe components. They are not used to indicate the priority order of or advance relationship, but only to distinguish components with the same name.

It should be noted that the technical features in different embodiments described in the following can be replaced, recombined, or mixed with one another to constitute another embodiment without depart in from the spirit of the present invention.

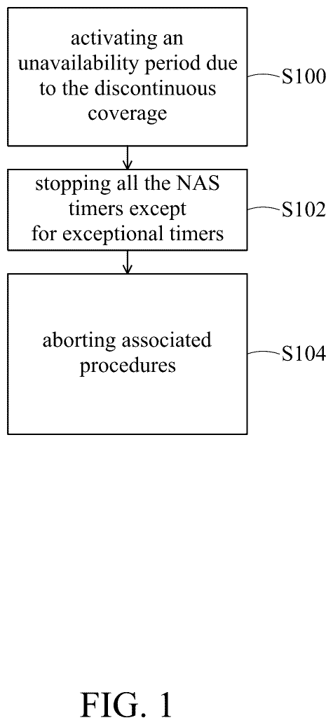

FIG. 1 shows a flow chart of a method to control non-access stratum (NAS) timers at or after discontinuous coverage in accordance with some embodiments of the present invention. The method to control the NAS timers at or after the discontinuous coverage is applied to user equipment (UE). In some embodiments, the UE may be, for example, a laptop, a tablet, a smart phone, a smart watch, etc., but the present invention is not limited thereto. As shown in FIG. 1, the method to control the NAS timers at or after the discontinuous coverage includes the following steps. An unavailability period is activated due to discontinuous coverage (step S100). All the NAS timers are stopped except for exceptional timers (step S102). Associated procedures are aborted (step S104). In some embodiments, the exceptional timers include T3412, T3346, T3396, T3447, any backoff timers, T3247, and a timer controlling a periodic search for an HPLMN or an EPLMN, or higher prioritized PLMNs, but the present invention is not limited thereto.

In some embodiments, the unavailability period in step S100 includes a period during the discontinuous coverage and/or a period when an access stratum of the UE is deactivated. Before step S100 is performed, the UE and a network may support a satellite E-UTRAN access in WB-S1 mode or NB-S1 mode with CIOT EPS optimization. Support for satellite E-UTRAN is specified in 3GPP TS 36.300 [20]. A mobility management entity (MME) of the network can determine the UE is accessing the network using a satellite E-UTRAN access and may enforce mobility restriction for the UE as specified in 3GPP TS 23.401 [10]. If the unavailability period is activated due to discontinuous coverage (step S100 in FIG. 1), as described in 3GPP TS 23.401 [10], all NAS timers are stopped except for the exceptional timers (step S102 in FIG. 1) and associated procedures are aborted (as described in 3GPP TS 23.122 [6]) (step S104 in FIG. 1).

In some embodiments, when an EPLMN list is present, the associated procedures are aborted except for the EPLMN. In some embodiments, if the unavailability period is activated due to discontinuous coverage, the UE may deactivate an access stratum.

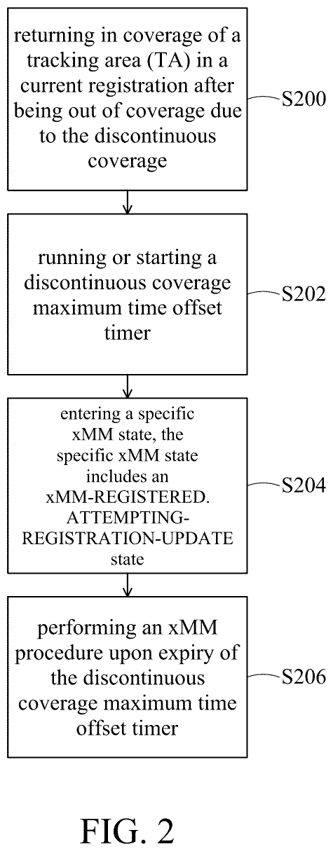

FIG. 2 shows a flow chart of a method to declare the state of user equipment (UE) at the end, and after the end, of discontinuous coverage in accordance with some embodiments of the present invention. The method to declare the state of the UE at and after the end of the discontinuous coverage is applied to the UE. In some embodiments, the UE may be, for example, a laptop, a tablet, a smart phone, a smart watch, etc., but the present invention is not limited thereto. As shown in FIG. 2, the method to declare the state of the UE at and after the end of the discontinuous coverage includes the following steps. The UE returns in coverage of a tracking area (TA) in a current registration after being out of coverage due to the discontinuous coverage (step S200). The UE runs or starts a discontinuous coverage maximum time offset timer (step S202). The UE enters a specific xMM state. The specific xMM state includes an xMM-REGISTERED.ATTEMPTING-REGISTRATION-UPDATE state (step S204). The UE performs an xMM procedure upon expiry of the discontinuous coverage maximum time offset timer (step S206). In some embodiments, the xMM-REGISTERED.ATTEMPTING-REGISTRATION-UPDATE state is a 5GMM-REGISTERED.ATTEMPTING-REGISTRATION-UPDATE state or an EMM-REGISTERED.ATTEMPTING-TO-UPDATE.

In some embodiments, if the UE has stored the discontinuous coverage maximum time offset as described in subclause 5.4.4.3, 5.5.1.2.4, and 5.5.1.3.4, upon returning to coverage of a tracking area (TA) in the current registration after being out of coverage due to discontinuous coverage, and in the last REGISTRATION ACCEPT message, the end of unavailability period report was set to “UE needs to report end of unavailability period”, the UE starts a discontinuous coverage maximum time offset timer (that is, the random timer in step S202) with a random value up to and including the stored discontinuous coverage maximum time offset for this PLMN and NR satellite access.

The UE enters 5GMM-REGISTERED.ATTEMPTING-REGISTRATION-UPDATE state and does not initiate any NAS signalling on that NR satellite access and PLMN while the discontinuous coverage maximum time offset timer (that is, the discontinuous coverage maximum time offset timer in step S202) is running. The UE stops the discontinuous coverage maximum time offset timer and initiate NAS signalling if the UE receives paging message, has pending emergency services, is establishing an emergency PDU session or is performing emergency services fallback procedure or when the UE enters a TAI outside the registration area. Upon expiry of the discontinuous coverage maximum time offset timer, the UE performs a registration procedure for mobility registration update.

In some embodiments, in the state entered at, during, or after the random timer is running, the UE does not initiate any 5GMM procedure, except for emergency services. The UE stays in the same 5GMM state like NO-Cell state until the random timer has expired.

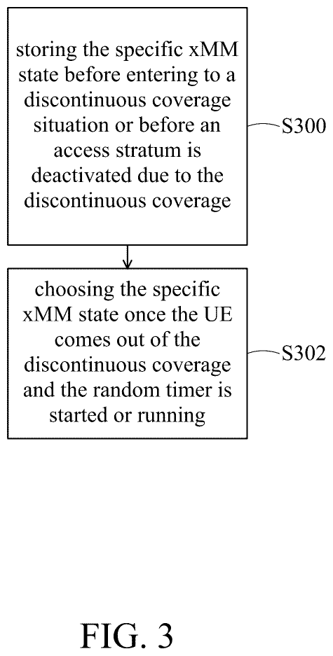

FIG. 3 shows a flow chart of the method to declare the state of the UE at and after the end of discontinuous coverage in FIG. 2 in accordance with some embodiments of the present invention. The method to declare the state of the UE at and after the end of the discontinuous coverage is applied to the UE. In some embodiments, the UE may be, for example, a laptop, a tablet, a smart phone, a smart watch, etc., but the present invention is not limited thereto. As shown in FIG. 3, the method to declare the state of the UE at and after the end of the discontinuous coverage includes the following steps. The specific xMM state is stored before entering a discontinuous coverage situation or before an access stratum is deactivated due to the discontinuous coverage (step S300). The specific xMM state is chosen once the UE comes out of the discontinuous coverage and the discontinuous coverage maximum time offset timer is started or running (step S302).

In some embodiments, when the unavailability period is activated, all NAS timers are stopped and associated procedures aborted except for timers T3512, T3346, T3447, T3396, T3584, T3585, any back-off timers, T3247, and the timer T controlling the periodic search for HPLMN or EHPLMN or higher prioritized PLMNs. In some embodiments, when the UE activates the unavailability period using a registration procedure without providing the start of the unavailability period, then after successful completion of the procedure the UE enters ta 5GMM-REGISTERED.NO-CELL-AVAILABLE state. Otherwise, if the UE provided the start of unavailability period in the registration procedure, the UE enters a 5GMM-REGISTERED.NO-CELL-AVAILABLE state only after the UE activates the unavailability period. In some embodiments, when the UE activates the unavailability period using the de-registration procedure, then after successful completion of the procedure the UE enters a 5GMM-DEREGISTERED.NO-CELL-AVAILABLE state.

In some embodiments, the specific xMM state may further be a 5GMM-DEREGISTERED.NORMAL-SERVICE state, and/or a 5GMM-DEREGISTERED.ATTEMPTING-REGISTRATION state, and/or a new state, e.g., a 5GMM-DEREGISTERED.DISCONTINUOUS-COVERAGE-WAITING state, and/or a 5GMM-DEREGISTERED.INITIAL-REGISTRATION-NEEDED state, and/or a 5GMM-REGISTERED.NORMAL-SERVICE state, and/or a 5GMM-REGISTERED.UPDATE-NEEDED state, and/or a new state, e.g., a 5GMM-REGISTERED.DISCONTINUOUS-COVERAGE-WAITING state.

In some embodiments, the specific xMM state may further be an EMM-DEREGISTERED.NORMAL-SERVICE in deregistered state, and/or an EMM-DEREGISTERED. ATTEMPTING-TO-ATTACH state, and/or a new state, e.g., and EMM-DEREGISTERED.DISCONTINUOUS-COVERAGE-WAITING state, and/or an EMM-DEREGISTERED.ATTACH-NEEDED state, and/or an EMM-REGISTERED.NORMAL-SERVICE state, and/or an EMM-REGISTERED.UPDATE-NEEDED state, and/or a new state, e.g., an EMM-REGISTERED.DISCONTINUOUS-COVERAGE-WAITING state.

In some embodiments, the UE stores the specific EMM state before entering a discontinuous coverage situation or before an access stratum is deactivated due to discontinuous coverage. The UE chooses the specific EMM state once the UE comes out of the discontinuous coverage and the random timer is started or running.

In some embodiments, the UE does not initialize any EMM procedures in a state entered at, during, or after the random timer is running, except for emergency services. The same EMM state includes an NO-Cell state.

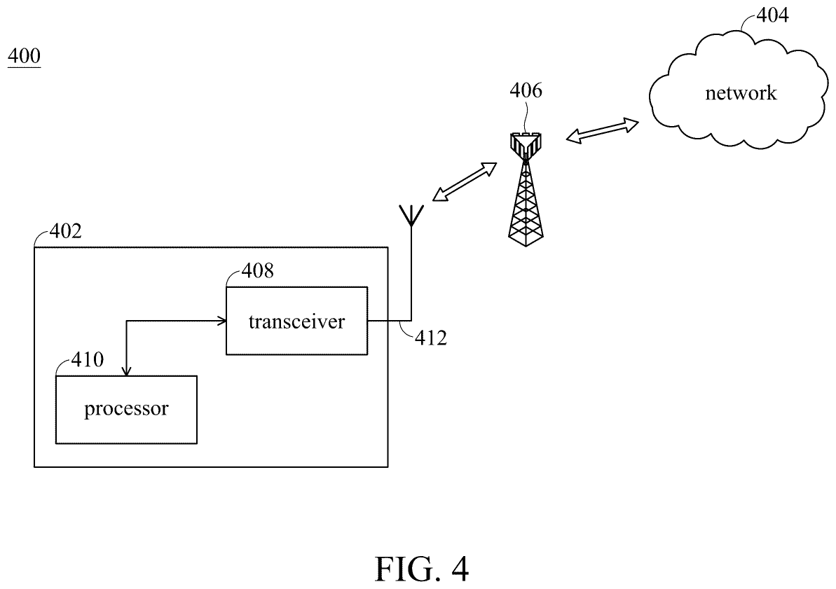

FIG. 4 shows a schematic diagram of a communication system 400 in accordance with some embodiments of the present invention. As shown in FIG. 4, the communication system 400 includes a UE 402, a network 404, and a base station 406. In some embodiments, the UE 402 may be a laptop, a tablet, a smart phone, or a smart watch, but the present invention is not limited thereto. In some embodiments, the UE 402 is able to access the network 404 through the base station 406. The UE 402 is connected with the base station 406 by Radio Resource Control (RRC) signaling, but the present invention is not limited thereto. In some embodiments, the base station 406 may be a gNB, but the present invention is not limited thereto.

In some embodiments, the UE 402 includes an antenna 412, a transceiver 408, and a processor 410. The transceiver 408 is electrically connected between the antenna 412 and the processor 410. The processor 410 may be a modem, but the present invention is not limited thereto. In some embodiments, the UE 402 further includes a memory (not shown) storing a plurality of codes. The processor 410 reads the codes stored in the memory to execute the steps as follows. In some embodiments, the processor 410 activates an unavailability period due to discontinuous coverage, stops all non-access stratum (NAS) timers except for exceptional timers, and aborts associated procedures. In some embodiments, the exceptional timers include T3412, T3346, T3396, T3447, any backoff timers, T3247, and a timer controlling a periodic search for an HPLMN or an EPLMN, or higher prioritized PLMNs. The unavailability period includes a period during the discontinuous coverage and/or a period when an access stratum of the UE 402 is deactivated.

In some embodiments, after the processor 410 aborts the associated procedures except for T3412, T3346, T3396, T3447, any backoff timers, T3247, and the timer controlling the periodic search for HPLMN or the EPLMN, or higher prioritized PLMNs, the processor 410 deactivates an access stratum. In some embodiments, when an EPLMN list is present, the associated procedures are aborted except for the EPLMN.

In some embodiments, the processor 410 returns in coverage of a tracking area (TA) in a current registration after being out of coverage due to the discontinuous coverage, runs or starts a discontinuous coverage maximum time offset timer, enters a specific xMM state, and performs an xMM procedure upon expiry of the discontinuous coverage maximum time offset timer. The specific xMM state includes an xMM-REGISTERED.ATTEMPTING-REGISTRATION-UPDATE state. In some embodiments, the xMM-REGISTERED.ATTEMPTING-REGISTRATION-UPDATE state is a 5GMM-REGISTERED.ATTEMPTING-REGISTRATION-UPDATE state or an EMM-REGISTERED.ATTEMPTING-TO-UPDATE.

In some embodiments, the xMM procedure is a registration procedure for mobility registration update or a tracking area updating procedure. In some embodiments, the processor 410 stores the specific xMM state before entering a discontinuous coverage situation or before an access stratum is deactivated due to the discontinuous coverage, and chooses the specific xMM state once the UE comes out of the discontinuous coverage and the discontinuous coverage maximum time offset timer is started or running.

In some embodiments, the processor 410 receives a last REGISTRATION ACCEPT message from a network. The last REGISTRATION ACCEPT message includes a report that the unavailability period has ended. The report that the unavailability period has ended indicates “UE does not need to report end of unavailability period”. The processor 410 chooses an appropriate substate of 5GMM-REGISTERED upon returning to coverage of a tracking area identity (TAI) in a current registration area. Due to the end of the unavailability period, the processor 410 does not perform a registration procedure for mobility registration update upon returning to coverage of the TAI in the current registration area.

In some embodiments, the processor 410 does not initialize any 5GMM procedures in a state entered at, during, or after the random timer is running, except for emergency services. The processor 410 stays in the same 5GMM state until the random timer has expired. The same 5GMM state includes an NO-Cell state.

In some embodiments, the processor 410 does not initialize any EMM procedures in a state entered at, during, or after the random timer is running, except for emergency services. The processor 410 stays in the same EMM state until the random timer has expired. The same EMM state includes an NO-Cell state.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method to control non-access stratum (NAS) timers at or after discontinuous coverage, applied to user equipment (UE), comprising:
activating an unavailability period due to discontinuous coverage;
stopping all the NAS timers except for exceptional timers; and
aborting associated procedures.

2. The method as claimed in claim 1, wherein the exceptional timers comprise T3412, T3346, T3396, T3447, any backoff timers, T3247, and a timer controlling a periodic search for a home public land mobile network (HPLMN) or an equivalent HPLMN (EHPLMN), or higher prioritized PLMNs.

3. The method as claimed in claim 1, further comprising:
deactivating an access stratum.

4. The method as claimed in claim 1, wherein the unavailability period comprises a period during the discontinuous coverage or a period when an access stratum of the UE is deactivated.

5. A method to declare a state of user equipment (UE) at and after an end of discontinuous coverage, applied to the UE, comprising:
returning in coverage of a tracking area (TA) in a current registration after being out of coverage due to the discontinuous coverage;
running or starting a discontinuous coverage maximum time offset timer;
entering a specific xMM state; and
performing an xMM procedure upon expiry of the discontinuous coverage maximum time offset timer;
wherein the specific xMM state comprises an xMM-REGISTERED.ATTEMPTING-REGISTRATION-UPDATE state.

6. The method as claimed in claim 5, wherein the xMM-REGISTERED.ATTEMPTING-REGISTRATION-UPDATE state is a 5GMM-REGISTERED.ATTEMPTING-REGISTRATION-UPDATE state or an EMM-REGISTERED.ATTEMPTING-TO-UPDATE.

7. The method as claimed in claim 5, wherein the xMM procedure is a registration procedure for mobility registration update or a tracking area updating procedure.

8. The method as claimed in claim 5, further comprising:
storing the specific xMM state before entering a discontinuous coverage situation or before an access stratum is deactivated due to the discontinuous coverage; and
choosing the specific xMM state once the UE comes out of the discontinuous coverage and the discontinuous coverage maximum time offset timer is started or running.

9. The method as claimed in claim 5, further comprising:
not initializing any xMM procedures in a state entered at, during, or after the discontinuous coverage maximum time offset timer is running, except for emergency services.

10. The method as claimed in claim 5, further comprising:
staying in the same xMM state until the discontinuous coverage maximum time offset timer has expired.

11. The method as claimed in claim 10, wherein the same xMM state comprises an NO-Cell state.

12. A user equipment (UE), comprising:
a processor, configured to activate an unavailability period due to discontinuous coverage, stop all non-access stratum (NAS) timers, and abort associated procedures except for exceptional timers, and abort associated procedures; or
wherein the processor is configured to return in coverage of a tracking area (TA) in a current registration after being out of coverage due to the discontinuous coverage, run or start a discontinuous coverage maximum time offset timer, enter a specific xMM state, and perform an xMM procedure upon expiry of the discontinuous coverage maximum time offset timer; and
wherein the specific xMM state comprises an xMM-REGISTERED.ATTEMPTING-REGISTRATION-UPDATE state.

13. The UE as claimed in claim 12, wherein the exceptional timer comprises are T3412, T3346, T3396, T3447, any backoff timers, T3247, and a timer controlling a periodic search for a home public land mobile network (HPLMN) or an equivalent HPLMN (EHPLMN), or higher prioritized PLMNs.

14. The UE as claimed in claim 12, wherein the xMM-REGISTERED.ATTEMPTING-REGISTRATION-UPDATE state is a 5GMM-REGISTERED.ATTEMPTING-REGISTRATION-UPDATE state or an EMM-REGISTERED.ATTEMPTING-TO-UPDATE.

15. The UE as claimed in claim 12, wherein the unavailability period comprises a period during the discontinuous coverage and/or a period when an access stratum of the UE is deactivated.

16. The UE as claimed in claim 12, wherein the xMM procedure is a registration procedure for mobility registration update or a tracking area updating procedure.

17. The UE as claimed in claim 12, wherein the processor is configured to store the specific xMM state before entering a discontinuous coverage situation or before an access stratum is deactivated due to the discontinuous coverage, and choose the specific xMM state once the UE comes out of the discontinuous coverage and the discontinuous coverage maximum time offset timer is started or running.

18. The UE as claimed in claim 12, wherein the processor is configured not to initialize any xMM procedures in a state entered at, during, or after the discontinuous coverage maximum time offset timer is running, except for emergency services.

19. The UE as claimed in claim 12, wherein the processor is configured to stay in the same xMM state until the discontinuous coverage maximum time offset timer has expired.

20. The UE as claimed in claim 19, wherein the same xMM state comprises an NO-Cell state.

21. The UE as claimed in claim 12, wherein the UE is configured to deactivate an access stratum.
